(19) United States
(12) Patent Application Publication
(10) Pub. No.: US 2005/0173264 A1
(43) Pub. Date: Aug. 11, 2005

(54) Device and method for measuring gas concentration

(75) Inventors: Torsten Reitmeier, Wackersdorf (DE); Tim Walde, Regensburg (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/514,195

(22) PCT Filed: May 6, 2003
(86) PCT No.: PCT/DE03/01447

(30) Foreign Application Priority Data
May 14, 2002 (DE) 102 21 392.5

(51) Int. Cl. G01N 27/26

(52) U.S. Cl. 205/783.5; 204/410

(57) ABSTRACT

The invention relates to a device and a method for measuring gas concentration in a measuring gas by means of a measuring sensor comprising an outer electrode (6) which is connected to a solid body electrolyte (2) and is exposed to the measuring gas, also comprising an electrode (9) which is connected to the solid electrolyte (2), between which oxygen can be pumped by means of a pump flow (Ip2) flowing through the solid electrolyte. The pump flow (Ip2) is driven between an electrode (9) and the outer electrode (16). A pulse sequence consisting of a plurality of individual pulses (15, 16, 17), having a pulse width (W), is used periodically as a pump flow. The pulse width (W) is adjusted in order to adjust the level of the pump flow (Ip2).

The invention relates to an apparatus for measurement of a gas concentration in a measurement gas, having an outer electrode which is connected to a solid electrolyte and is subjected to the measurement gas, and having an electrode, which is connected to the solid electrolyte, between which oxygen can be pumped by means of a pump flow flowing through the solid electrolyte, with a pump flow unit which drives the pump flow being connected between the electrode and the outer electrode.

The invention also relates to a method for measurement of a gas concentration in a measurement gas by means of a measurement sensor which has an outer electrode, which is connected to a solid electrolyte and is subjected to the measurement gas, and an electrode, which is connected to the solid electrolyte, between which oxygen can be pumped by means of a pump flow flowing through the solid electrolyte, and with the pump flow being driven between the electrode and the outer electrode.

It is known for a thick film measurement sensor to be used for measurement of the NOx concentration in a measurement gas, for example the exhaust gas from an internal combustion engine. One such measurement sensor is described, by way of example, in DE 199 07 947 A1. This measurement sensor has two measurement cells in a body composed of zirconium oxide, which conducts oxygen ions. The measurement concept is as follows: a first oxygen concentration is set by means of a first oxygen ion pump flow in a first measurement cell, to which the measurement gas is supplied via a diffusion barrier, with the aim that there should be no decomposition of NOx. In a second oxygen ion pump flow. The decomposition of NOx on a measurement electrode located in the second measurement cell leads to a third oxygen ion pump flow, which is a measure of the NOx concentration. The entire measurement sensor is in this case raised to a temperature of, for example, 750° C. by means of an electrical heater.

In order to set the oxygen ion pump flows, a Nernst voltage is tapped off in the respective measurement cells, with reference always being made to an oxygen content to which a reference electrode is subject, normally to that of the surrounding air.

Flow sources which use a control loop to set the oxygen concentration to an intended value are used for the pump flows. The quality of the flow sources is thus important for the achievable measurement accuracy and proof limit. This applies in particular to the flow source which is connected between the measurement electrode and the outer electrode.

The requirement to set the pump flow accurately results in considerable requirements for the temperature response of the circuit driving the respective pump flow, that is to say the pump flow source. This also applies to interference leakage currents, which likewise have a negative effect on the constancy and the accuracy of the pump flow which sets the oxygen concentration. The latter disadvantage is particularly important in the case of small pump flows, such as those which occur from the measurement electrode to the outer electrode.

U.S. Pat. No. 6,301,951 B1 describes a method for driving a measurement sensor for determination of an oxygen concentration in a gas mixture, in particular in exhaust gases from internal combustion engines. In this method, a detection voltage, which corresponds to the oxygen concentration and is produced by a Nernst measurement cell, is transferred from a circuit arrangement to a pump voltage for a pump cell. Depending on the oxygen content of the gas mixture, an anodic or a cathodic limiting current flows via the pump cell. During steady-state operation of the measurement sensor, during which an anodic limiting current flows for a time period which can be selected, the pump cell and/or the Nernst measurement cell have/has at least one voltage pulse applied to them/it, which is produced independently of the measured detection voltage and of the pump flow that is set, so as to depolarize the measurement sensor.

GB 2 252 167 A describes an oxygen sensor system having a solid electrolyte. The system has a reference volume which is connected through a hole or pores to an area with an external measurement gas, and is bounded by an oxygen pump with the solid electrolyte and an oxygen sensor with a solid electrolyte. Both the oxygen pump and the oxygen sensor have an electrode in the reference volume, and a further electrode in the measurement gas. A regulated heater keeps the temperature of the sensor at a desired value. The electrodes of the oxygen pump are supplied with a sinusoidal current, which leads to a pseudo-sinusoidal electromotive force of the oxygen sensor, whose amplitude is measured in order to determine the oxygen partial pressure of the measurement gas. Furthermore, the phase of the pseudo-sinsuoidal electromotive force is measured, thus allowing more accurate determination of the oxygen partial pressure in the measurement gas, of the barometric pressure and diagnostic information relating to faults in the sensor.

GB 2 270 164 A describes an oxygen measurement system which uses a sensor with a solid electrolyte, and a pump. This system has an enclosed volume which is bounded by an oxygen pump with a solid electrolyte, and by an oxygen sensor with a solid electrolyte. Both the oxygen pump and the oxygen sensor have an electrode in the enclosed volume, and another electrode in a measurement gas. An electromotive force from the sensor is compared with a separately produced periodically oscillating voltage, and the difference between the electromotive force and the voltage is kept constant by means of a control loop which controls the current to the oxygen pump. The resultant periodically oscillating pump flow is analyzed in order to determine the oxygen partial pressure and/or the oxygen concentration in the measurement gas.

EP 0 427 958 A1 describes an apparatus for supplying electrical power to an oxygen pump which is part of a linear oxygen probe. The apparatus has a bridge circuit of transistors, which are controlled by a microprocessor. The microprocessor processes measurement signals from a measurement cell from the probe, in order to control the direction and duration of a flow of predetermined intensity through an oxygen pump. A periodic alternating current at a fixed frequency and with a variable cyclic switched-on duration is produced by switching the transistors in the bridge.

The requirements for temperature stabilization and a low leakage current level can admittedly be made less stringent by using a pulse-width-modulated pump flow but this would result in a certain amount of modulation of the oxygen concentration at the electrode, resulting in corresponding requirements for the insensitivity of the electrode to fluctuating oxygen concentrations. The life

The requirements for temperature stabilization and a low leakage current level could admittedly be made less stringent by using a pulse-width-modulated pump flow but this would result in a certain amount of modulation of the oxygen concentration at the electrode, resulting in corresponding requirements for the insensitivity of the electrode to fluctuating oxygen concentrations. The life of the electrode and hence of the measurement apparatus may thus be reduced. The measurement accuracy is also reduced.

The invention is based on the object of developing the apparatus mentioned initially and the method mentioned initially such that the electrode is not loaded as much.

In the case of an apparatus of the generic type, this object is achieved according to the invention in that the pump flow unit periodically emits a pulse sequence of two or more individual pulses with a pulse width, with the pulse width being variable in order to set a level for the pump flow.

In the case of a method of the generic type, the object is achieved according to the invention in that a pulse sequence having a number of individual pulses with a pulse width is used periodically as the pump flow, with the pulse width being set in order to set a level for the pump flow.

The invention therefore adopts a middle line between a direct current and a purely pulse-width-modulated pump flow and thus, surprisingly, links the advantages of both of these concepts. The temperature response of the circuit and leakage currents essentially act only during the relatively short time for which the pump flow is switched on; outside the individual pulses, only a leakage flow occurs, which is negligible in comparison to this. At the same time, the pulse sequence results in the modulation of the oxygen content at the electrode being considerably less than if pulse-width modulation at a fixed pulse frequency and with an individual pulse whose pulse width is modulated were to be used.

Since there are a number of individual pulses within the pulse sequence, the pulse magnitude can be kept low when designed for the same effective flow magnitude, so that little oxygen modulation occurs, which has a positive effect on the aging behavior of the electrode, and on the measurement accuracy. A measurement uninfluenced by pump flow changes can be carried out in the pauses in which none of the individual pulses in the pulse sequence occur, and, in particular, there are then no adverse effects resulting from rising or falling flanks of the pump flow. This also applies to pulsed heating.

The pump flow configuration according to the invention can be used for all pump flow sources for the measurement sensor. Particular advantages in terms of measurement signal improvement are obtained when used for the pump flow source, which drives an oxygen ion pump flow between the outer electrode and the measurement electrode.

The pulse widths of the individual pulses in the pulse sequence are varied, with all of the individual pulses in a pulse sequence having the same pulse width. In this case, the pump flow may be controlled particularly easily if the individual pulses have rising flanks with a fixed time interval between them. The number of individual pulses and the fixed time interval then govern the maximum duty ratio, that is to say the proportion of the period at which the pulse sequence is repeated for which the individual pulses may occupy it.

The number of individual pulses can be varied as a function of the application. Pulse sequences with 2 to 10 individual pulses are expedient. Ultimately, this depends on the pump flow source and on the frequency at which it can be driven.

A particularly advantageous drive ratio for NOx sensors is obtained if the fixed time interval between the rising flanks is between 1/20 and ¼ of the period of the pulse sequence.

The pulse width can be set by means of a suitable regulator. This can be achieved particularly easily by using a microcontroller which drives the pump flow unit with respect to the pulse width of the individual pulses.

Particularly good pump flow control flexibility is achieved if the number of individual pulses is variable. In this case, the modulation width can be increased or decreased by adding or removing individual pulses, thus allowing a modulation level of up to 100%. This is particularly advantageous when a considerably higher pump flow is required in a starting phase of a measurement flow sensor than during the subsequent, normal operation.

The invention will be described in more detail in the following text, with reference, by way of example, to the drawing, in which:

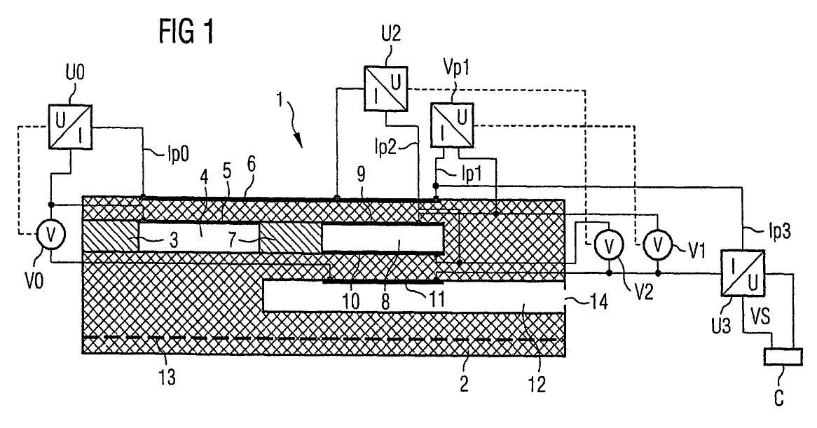

FIG. 1 shows a schematic section illustration through an NOx measurement sensor with the associated circuitry,

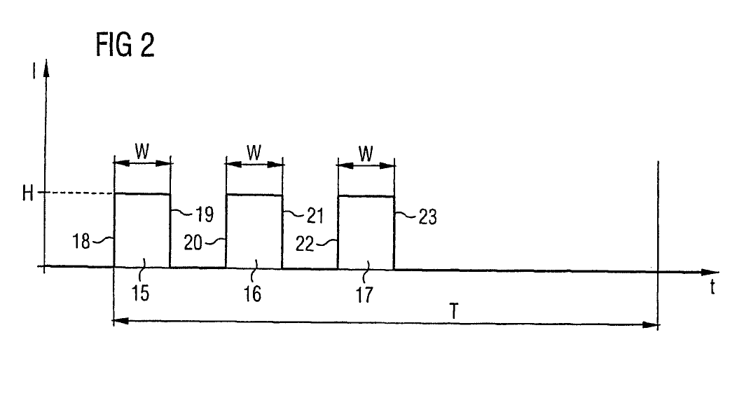

FIG. 2 shows the timing of the pump flow which has a periodically repeated pulse sequence with individual pulses, and

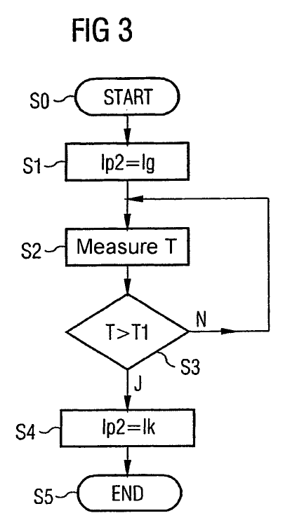

FIG. 3 shows a flowchart of an operating method for the measurement sensor shown in FIG. 1.

FIG. 1 shows a schematic section through an NOx measurement sensor which detects the NOx concentration in the exhaust gas system of an internal combustion engine. This measurement sensor 1 which is formed from a solid electrolyte, in the example ZrO₂, detects the exhaust gas, which is to be measured and whose NOx concentration is intended to be determined, via a diffusion barrier 3.

The entire measurement sensor 1 is raised to its operating temperature by means of a heater 13 with a pulsed current.

The exhaust gas diffuses through the diffusion barrier 3 into a first measurement cell 4. The oxygen content in this measurement cell 4 is measured by tapping off a first Nernst voltage V0 between a first electrode 5, which is located in the first measurement cell 4, and a reference electrode 11 which is arranged in a reference cell 12. The reference cell 12 is largely sealed from the surrounding air, with suitable measures being taken to equalize the pressure when the environmental pressure changes. A pressure equalizing opening 14 in the form of a pin hole is provided for this purpose in the exemplary embodiment.

The Nernst voltage V0 is related to the oxygen content in the reference cell 12 in which the reference electrode 11 is located. The significance of this situation will be explained in more detail later.

A first circuit arrangement sets a predetermined oxygen concentration in the first measurement cell 4. For this purpose, the first Nernst voltage V0 is tapped off by a regulator, which sets a voltage-controlled flow source U0 which drives a first oxygen ion pump flow Ip0 through the solid electrolyte 2 of the measurement sensor 1 between the first electrode 5 and an outer electrode 6. In this case, a predetermined oxygen concentration is produced in the first measurement cell 4, and is measured via the Nernst voltage V0 between the electrode 5 and the reference electrode 11. The detection of the first oxygen ion pump flow Ip0 is detected, as is required for control purposes, via the known characteristic of the pump flow source U0, on the basis of which the pump flow is linked directly to a control voltage.

The second measurement cell 8 is connected to the first measurement cell 4 via a further diffusion barrier 7. The gas in the first measurement cell 4 diffuses through this diffusion barrier 7 into the second measurement cell 8.

A second circuit arrangement produces a second oxygen concentration in the second measurement cell. For this purpose, a second Nernst voltage V1 is tapped off between a second electrode 9 and the reference electrode 11, and is supplied to a regulator which sets a second voltage-controlled flow source U1, by means of which a second oxygen ion pump flow Ip1 is driven from the second measurement cell 8, in order to further reduce the oxygen content in the second measurement cell 8. In this case as well, the characteristic of the flow source U1 is used to control the second oxygen ion pump flow Ip1.

The second circuit arrangement controls the second oxygen ion pump flow Ip1 such that a predetermined oxygen concentration is produced in the second measurement cell 8. This is in this case sufficiently high that NOx is not affected by the processes taking place, and in particular it does not decompose. The NOx in the second measurement cell 8 at a measurement electrode 10 (which may be designed to operate catalytically) is now pumped from the measurement electrode 10 toward the outer electrode 6 in a third oxygen ion pump flow Ip2. Since the residual oxygen content in the measurement cell 8 has been reduced so far that the oxygen ion pump flow Ip2 essentially comprises only oxygen ions which originate from the decomposition of NOx adjacent to the measurement electrode 10, the pump flow Ip2 is a measure of the NOx concentration in the measurement cell 8, and thus in the exhaust gas to be measured. The third oxygen ion pump flow Ip2 is likewise driven by a voltage-controlled flow source U2, which is controlled by measurement of a third Nernst voltage V2. A regulator which taps off the third Nernst voltage V2 between the measurement electrode 10 and the reference electrode 11 is provided in this case, analogously to the already mentioned pump flows.

In order to produce a constant reference potential in the reference electrode 11 during the measurements of the Nernst voltages, the reference cell 12 is essentially sealed from the surrounding air. Furthermore, as a result of unavoidable diffusion processes, an oxygen partial pressure which is higher than that of the surrounding area is produced in the reference cell 12 by using a fourth controlled flow source U3 to drive a fourth oxygen ion pump flow Ip3 from the outer electrode to the reference electrode 11, pumping the oxygen into the reference cell 12. The flow source U3 is in this case controlled by means of a control voltage VS which is emitted from a controller C. An analog circuit may also optionally be used in this case, as for all flow control loops.

The pump flows are in this case set in accordance with the following scheme, which is illustrated in FIG. 2 and which, by way of example, refers to the third pump flow Ip2.

FIG. 2 shows the timing of the pump flow I. As can be seen, a pulse sequence is repeated with a period T. The pulse sequence comprises three individual pulses, a first individual pulse 15, a central individual pulse 16 and a final individual pulse 17, which all have the same pulse width W and the same pulse magnitude H.

While the pulse magnitude H remains unchanged, the pulse width W is varied in order to set the level of the pump flow Ip2. In this case, there is a fixed time interval between a rising flank 18 of the first individual pulse 15, a rising flank 20 of the central individual pulse 16, and a rising flank 22 of the final individual pulse 17. The width W is varied by varying the timing of a falling flank 19 of the first individual pulse 15, a falling flank 21 of the central individual pulse 16 as well as a falling flank 23 of the final individual pulse 17 with respect to the respective rising flanks 18, 20, 22. A delay increases the pulse width W, while an advance shortens it.

The pulse sequence shown in FIG. 2 is repeated once the period T has elapsed, in which case the control loop can then vary the pulse width W.

The fixed time interval between the rising flanks 18, 20 and 22 in the case of the pulse sequence illustrated in FIG. 2 with three individual pulses 15, 16 and 17 results in the modulation level, that is to say the proportion of the period T in which the pump flow is at the level H, remaining considerably less than 100%. Additional individual pulses may be added briefly in order to raise this.

This increase in the modulation level is carried out in starting phases of the measurement sensor according to the following method, which is illustrated in FIG. 3, in order to start the process up more quickly:

After a step S0 in which the method is started, the individual pulses are first of all set to the maximum possible width W in a step S1 for modulation. The large width W results in a high mean flow level Ig, which is chosen such that it does not result in destruction or excessive degradation of the outer electrode 6 which carries it, of the solid electrode 2 or of the measurement electrode 9. However, it is sufficiently large that the voltage which is caused by contact resistances would not result in the corresponding Nernst voltage being measured with unacceptable errors. In this starting phase, in which the third pump flow Ip2 transports oxygen from the outer electrode 6 to the measurement electrode 9, the measurement sensor 1 is therefore no longer used for measurement purposes. The time period since the pump flow Ip2 with the large pulse width W was selected is recorded in a step S2.

The process does not continue with the step S4 until it is found in a step S3 that the high mean flow level Ig has flowed for a certain time T1, otherwise the process jumps back to before the time measurement step S2.

In the step S4, the pump flow Ip2 from the outer electrode 6 to the measurement electrode 9 is reduced to a considerably lower mean flow level Ik by shortening the width W. The low mean flow level Ik is chosen such that the oxygen ion pump flow Ip2 is then suitable for measurement purposes. The low mean flow level Ik now does not unacceptably corrupt the detection of the Nernst voltages, so that the measurement process is carried out until the operation of the measurement sensor 1 is ended in a step S5.

1. An apparatus for measurement of a gas concentration in a measurement gas, having
an outer electrode (6) which is connected to a solid electrolyte (2) and is subjected to the measurement gas, and having an electrode (9), which is connected to the solid electrolyte (2), between which oxygen can be pumped by means of a pump flow (Ip2) flowing through the solid electrolyte (2),
with a pump flow unit (U2) which drives the pump flow (Ip2) being connected between the electrode (9) and the outer electrode (6), characterized in that the pump flow unit (U2) periodically with a predetermined period emits a pulse sequence of two or more individual pulses (15, 16, 17) with a pulse width (W), with the pulse width (W) being variable once a period has elapsed in order to set a level for the pump flow (Ip2).

2. The apparatus as claimed in claim 1, characterized in that the individual pulses (15, 16, 17) have rising flanks (18,20,22) with a fixed time interval between them.

3. The apparatus as claimed in claim 2, characterized in that the interval is between 1/20 and ¼ of the period of the pulse sequence.

4. The apparatus as claimed in claim 1, characterized in that the pulse sequence has between 2 and 10 individual pulses.

5. The apparatus as claimed in claim 1, characterized by a microcontroller (C), which drives the pump flow unit (U2) with respect to the pulse width (W) of the individual pulses (15, 16, 17).

6. The apparatus as claimed in claim 1, characterized in that the number of individual pulses (15, 16, 17) is variable.

7. A method for measurement of a gas concentration in a measurement gas by means of a measurement sensor which has
an outer electrode (6), which is connected to a solid electrolyte (2) and is subjected to the measurement gas, and an electrode (9), which is connected to the solid electrolyte (2), between which oxygen can be pumped by means of a pump flow (Ip2) flowing through the solid electrolyte (2),
and with the pump flow (Ip2) being driven between the reference electrode (11) and the electrode (16),
characterized in that
a pulse sequence having a number of individual pulses (15, 16, 17) with a pulse width (W) is used periodically with a predetermined period as the pump flow, with the pulse width (W) being set once a period has elapsed in order to set a level for the pump flow (Ip2).

8. The method as claimed in claim 7, characterized in that the individual pulses (15, 16, 17) have rising flanks (28, 22) with a fixed time interval between them.

9. The method as claimed in claim 8, characterized in that the interval is between 1/20 and ¼ of the period of the pulse sequence.

10. The method as claimed in claim 7, characterized in that the pulse sequence has between 2 and 10 individual pulses.

11. The method as claimed in claim 7, characterized in that the number of individual pulses (15, 16, 17) is variable.
